(19) United States
(12) Patent Application Publication
(10) Pub. No.: US 2003/0225616 A1
(43) Pub. Date: Dec. 4, 2003

(54) Customer management method using point giving of prise winning type with customer

(76) Inventor: Kook-Ho Park, Seoul (KR)

Correspondence Address: F. Chau & Associates, LLP, Suite 501, 1900 Hempstead Turnpike, East Meadow, NY, 11554, US

(21) Appl. No.: 10/205,944

(22) Filed: Jul. 26, 2002

(30) Foreign Application Priority Data
Jun. 4, 2002 (KR) 2002-31306

(51) Int. Cl. G06F 17/60

(52) U.S. Cl. 705/14

(57) ABSTRACT

A customer management method can attract customers' interest through prize-winning, and increase customers' anticipation and concern, thereby enabling regular customers to be secured. The method enables customers to receive discriminated service and privilege through dividend of goods and enables shops to increase sales by securing regular customers. In the method, a card in which an initial point number according to an initial purchase is initially encoded issued and provided for a customer, when the customer purchases a product. Then, a predetermined number of symbols corresponding to a point number according to purchase of products is printed and accumulated whenever the customer purchases products, together with at least one prize-winning character corresponding to the symbols. Then, the customer is provided with a prize corresponding to a prize-winning point set in advance, when the accumulated characters correspond to the prize-winning point.

### TECHNICAL FIELD

The present invention relates to a method of managing customers, and more particularly to a customer management method using point giving of a prize-winning type with customers, in which characters according to preset points are printed on a card for a customer purchasing products and prizes are given to the customer when the characters meet a predetermined requirement.

### BACKGROUND ART

With the spread of computers and the Internet to the populace, there have recently appeared many electronic commerce sites for selling goods through the Internet, thereby minimizing the marketing cost and improving competitiveness of the price of the goods.

Existing electronic commerce sites mostly employ a marketing method in which points determined in advance for each product are provided for a customer when the customer purchases the product, and various services are provided for the customer when the repayment points reach a predetermined level after being accumulated, thereby improving the quality of service and arousing customers' interest.

Further, in the point system, which is employed by the electronic commerce sites as described above in order to induce customers to continuously visit the sites and purchase goods, a number of points estimated according to a predetermined proportion of a price for specific goods are provided and accumulated for a customer whenever the customer purchases the specific goods, and the accumulated points are converted into money when the accumulated points reach at least a predetermined level, so as to enable the customer to purchase goods at a price reduced by the amount of money estimated from the accumulated points.

In the above-mentioned method of accumulating a point according to purchase record, which is usually employed in existing credit card companies, although the repayment points for individual customers are managed on-line, the points can be confirmed only through a receipt separately printed when the products are purchased, but there is no way for the customer to confirm the accumulated point total.

Therefore, in the above conventional method, when a customer does continuous business with the electronic commerce sites employing the method, the customer cannot easily confirm the accumulated contents of previous dealing particulars, and the accumulated points, according to which the repayment amount is already uniformly determined, cannot attract the customer's interest.

### DISCLOSURE OF THE INVENTION

Accordingly, the present invention has been made to solve the above-mentioned problems occurring in the prior art, and an object of the present invention is to provide a customer management method of a type using point-giving for prize winning, in which characters corresponding to a point total set in advance for purchased products are printed on a card when a customer purchases the goods, and a predetermined service is provided for the customer when a point total corresponding to the number of the printed characters has been accumulated.

It is another object of the present invention to provide a customer management method of a type using point-giving for prize winning, which can attract customers' interest through prize winning, and increase customers' anticipation and concern, thereby enabling regular customers to be secured.

It is another object of the present invention to provide a customer management method of a type using point-giving for prize winning, which enables customers to receive discriminated service and privilege through dividend of goods and enables shops to increase sales by securing regular customers.

It is another object of the present invention to provide a customer management method of a type using point-giving for prize winning, in which cards are issued after being previously encoded with prize-winning points according to total number of cards to be issued, so that the prize-winning points corresponding to the issued cards can be exactly managed, and prizes to be repaid to the customer for the prize-winning can be managed in advance according to a schedule.

It is another object of the present invention to provide a customer management method of a type using point-giving for prize winning, in which information and data about customers including sales record of shops can be accumulated and utilized in determining the prize-winning probabilities and points for cards to be issued in the future, thereby increasing the sales of the shops and the customers' satisfaction.

In order to accomplish this object, there is provided a customer management method comprising the steps of: (1) issuing a card, in which an initial point number according to an initial purchase is initially encoded, and providing a customer with the card when the customer purchases a product; (2) printing and accumulating a predetermined number of symbols corresponding to a point number according to purchase of products whenever the customer purchases products, together with at least one prize-winning character corresponding to the symbols; and (3) providing the customer with a prize corresponding to a prize-winning point set in advance, when the accumulated characters correspond to the prize-winning point.

Further, in the customer management method, a number of cards to be issued, the prize-winning point, and point numbers set for the products are determined based on data relating to customers and customers' purchase record stored and accumulated. Further, a prize-winning point total is differently distributed to and encoded in cards issued numbers of which are different according to the point numbers.

Also, in the customer management method, inputting a total number of cards to be issued; inputting a prize-winning point total of the cards; inputting prize-winning point numbers according to kinds of the cards; inputting a number of cards to be issued according to the prize-winning point numbers; and issuing the cards according to the prize-winning point numbers.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram for describing a customer management method using point giving of prize-winning type with customer according to the present invention;

FIG. 2 is a diagram showing the flow of steps in a customer management method using point giving of prize winning type with customer according to the present invention;

FIG. 3 is a flowchart of a method of distributing the prize-winning point total for each card when the card is issued, which is employed in the customer management method shown in FIG. 2;

FIG. 4A is a view schematically describing several states of a card, which shows a process in which points are accumulated according to a customer's using of the card and the prize-winning is determined; and

FIG. 4B is a view schematically describing several states of a card, which shows another process in which points are accumulated according to a customer's using of the card and the prize-winning is determined.

### BEST MODE FOR CARRYING OUT THE INVENTION

Hereinafter, a customer management method using point giving of prize-winning type with customer according to the present invention will be described in detail with reference to the accompanying drawings.

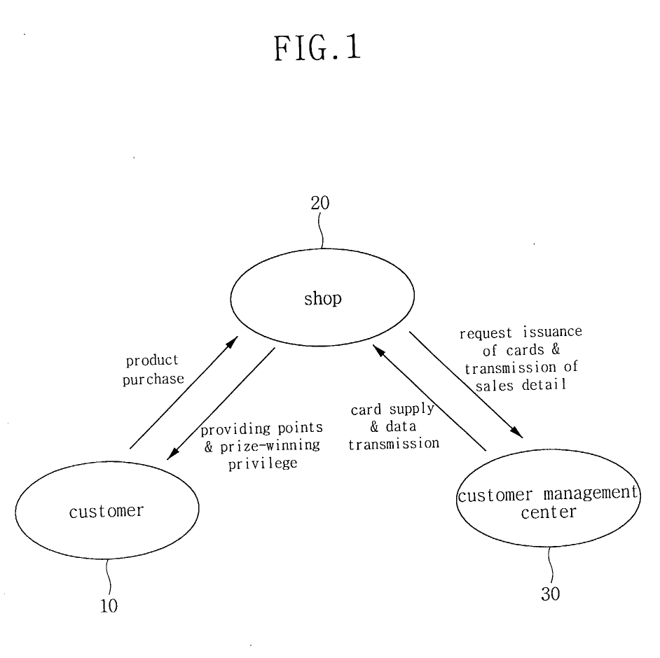

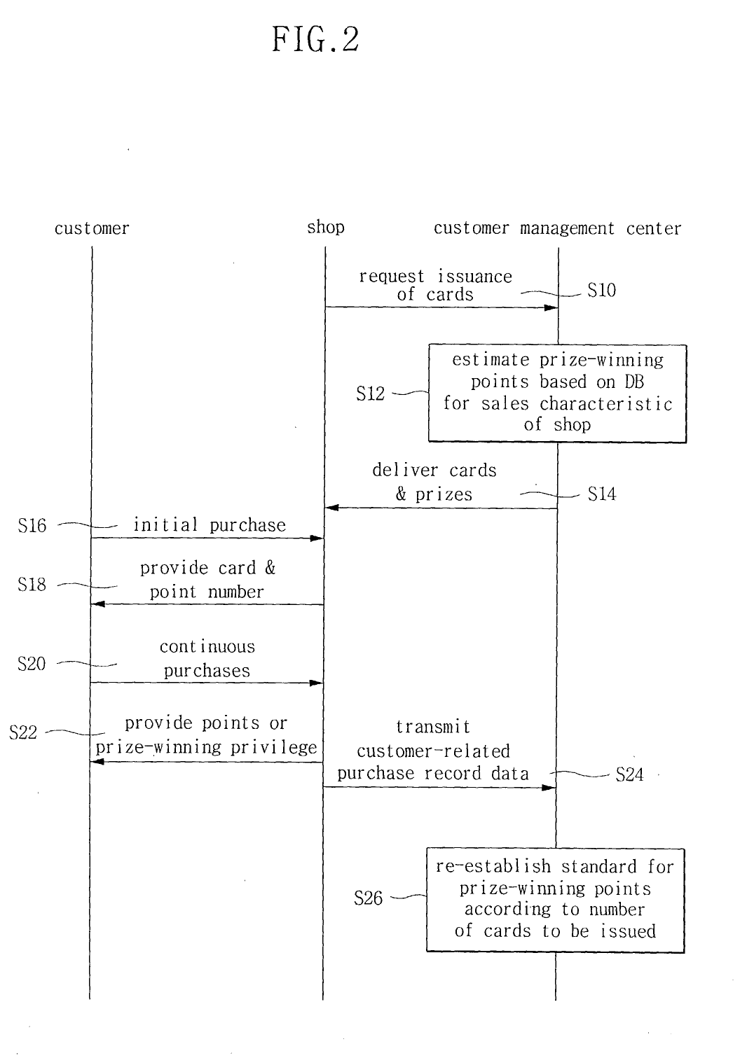

FIG. 1 is a block diagram for describing a customer management method using point giving of prize-winning type with customer according to the present invention, and FIG. 2 is a diagram showing the flow of steps in a customer management method using point giving of prize winning type with customer according to the present invention.

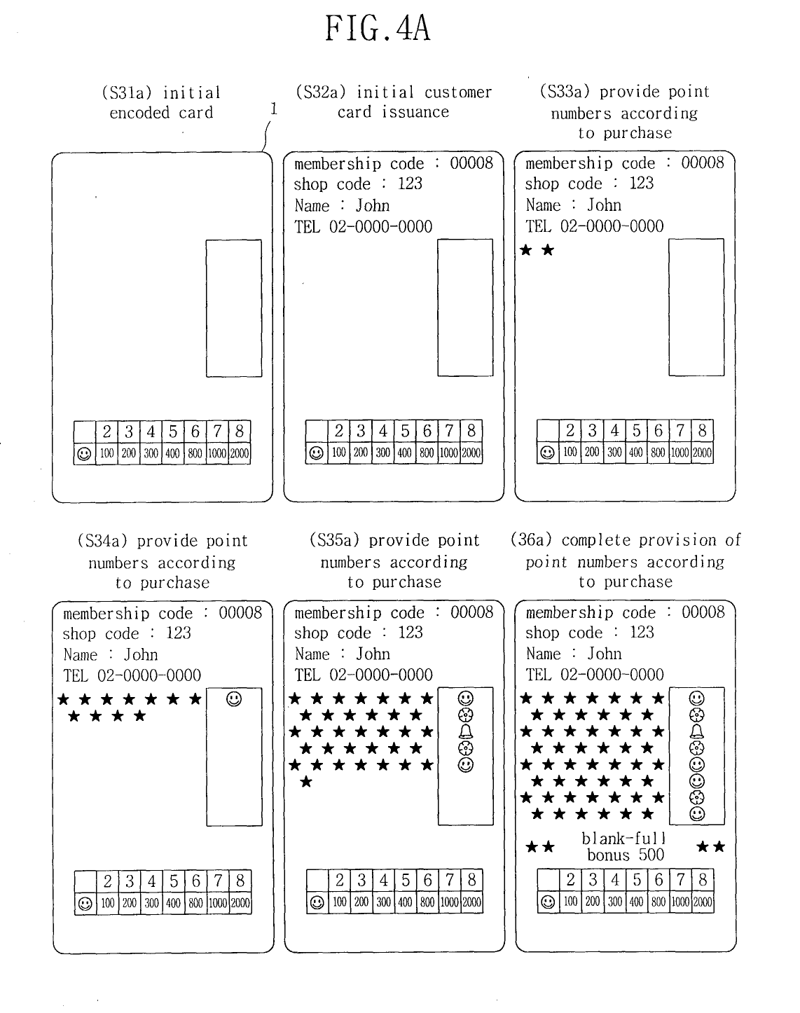

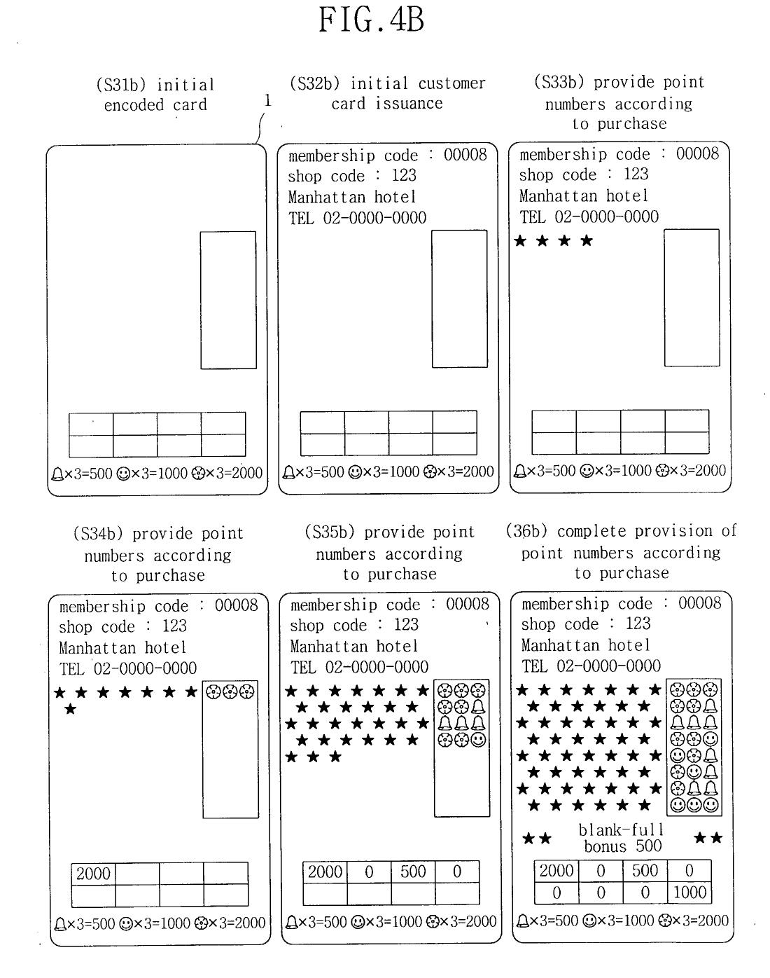

First, in a brief description about a customer management method using point giving of prize-winning type with customer according to the present invention, a card 1 as shown in FIG. 4A, on which characters and letters can be printed and magnetic information can be recorded, is provided for a customer when the customer purchases goods for the first time, and corresponding number and kind of characters corresponding to points set in advance for various products, are printed on the card 1 whenever the customer purchases an article. When the characters meet a predetermined requirement, a prize is provided for the customer.

As shown in FIGS. 1 and 2, when a shop 20 makes a request on behalf of a customer 10 for a card 1 to a customer management center 30 through a communication network (not shown), preferably through the Internet, in order to provide a customer 10 with the card 1, the customer management center 30 estimates a prize-winning point number according to the number of issued cards 1 based on database for the sales characteristics of the shop making the request (step S12), and issues and sends the card 1 to the shop 20 which requested the repayment prize or premium, together with a repayment prize or premium corresponding to the estimated prize-winning point total.

When the initial purchase at the shop 20 by the customer 10 has been carried out (step S16), the shop 20 provides the customer 10.with the card 1 together with a point number according to the initial purchase. Thereafter, if the customer 10 does continuous business with the shop 20 (step S20), the shop 20 continuously provides points for the customer 10. In this case, the points are expressed by characters printed on the card 1 of the customer 10. When the points increase through accumulation of the characters and reach a predetermined level, that is, a prize-winning point total, the shop 20 provides the customer 10 with a privilege such as a repayment prize or premium.

In this way, the customer 10 can continuously confirm upcoming opportunities for prize-winning with reference to the prize-winning point total according to the purchase record, printed as characters on the card possessed by the customer 10, together with an advisement of the prize-winning points printed in advance on the card 1. As a result, the shop 20 can attract the customer's interest and make the customer 10 have anticipation and concern whenever the customer 10 purchases goods, thereby securing more regular customers.

Meanwhile, the shop 20 transmits customer-related sales data, such as sales record to the customer and prize-provided status, to the customer management center 30 (step S24).

Subsequently, the customer management center 30 analyzes the quality of service for and change in satisfaction degree of the customer 10 on the basis of the customer-related sales data transmitted from the shop 20, and re-establish a standard for a prize-winning number of points for each card issued in the future, on the basis of the analysis (step S26), and then provides the shop 20 with the above-described service including issuing the cards, thereby enabling the shop 20 to anticipate a sales increase.

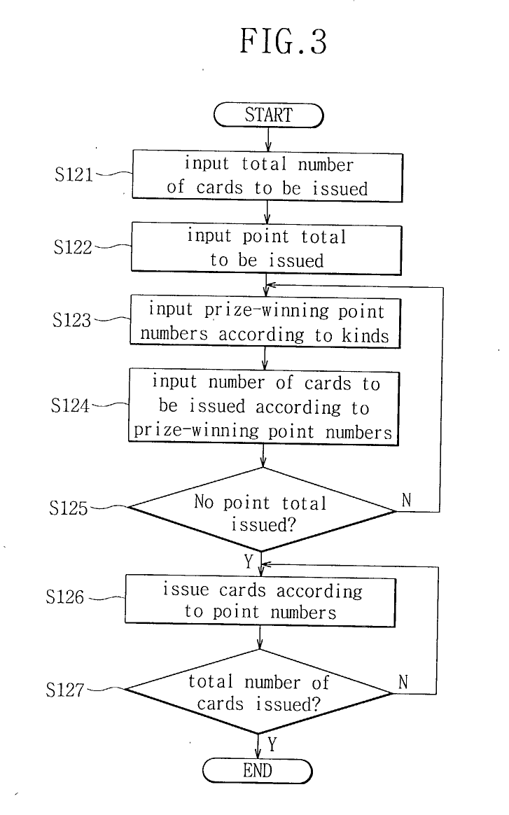

FIG. 3 is a flowchart of a method of distributing the prize-winning point total for each card when the card is issued, which is employed in the customer management method shown in FIG. 2.

As shown, the number of cards to be issued, which is requested by the shop 20, is firstly inputted into database (step S121), and a prize-winning point total for the card 1 to be issued is inputted (step S122). Next, among the prize-winning point total, point numbers to be practically provided for the customer 10 are inputted according to the kinds (step S123), and the number of issued cards according to the kinds is inputted (step S124). Thereafter, the point numbers to be issued according to the kinds are inputted until the prize-winning point total is completely inputted (step S125).

When the prize-winning point total is completely inputted, cards are issued according to the prize-winning point numbers (step S126), and whether or not exact numbers of cards are issued according to the prize-winning point numbers is examined (step S127), so that cards are newly issued when the number of issued cards is insufficient while the process is directly ended when the number of issued cards is exact.

For example, when the number of cards to be issued, which is requested by the shop, is one thousand sheets, and the prize-winning point total is five hundred thousand points, the numbers of cards to be issued according to the prize-winning point numbers are as follows: the number of cards with two hundred points is five hundred sheets, thereby making a total of one hundred thousand points; the number of cards with five hundred points is two hundred sheets, thereby making a total of one hundred thousand points; the number of cards with one thousand points is two hundred sheets, thereby making a total of two hundred thousand points; the number of cards with two thousand points is fifty sheets, thereby making a total of one hundred thousand points; and the number of cards with zero points is one hundred and fifty sheets, thereby making a total of zero points; as a result, a total of one thousand cards represent five hundred thousand points.

In the method as describe above, in which the prize-winning point total is distributed to and encoded in cards issued numbers of which are different according to the point numbers, the card 1 in which the point numbers are encoded and recorded as magnetic information are delivered to the customer 10. Therefore, the repayment prize can be paid according to the encoded point number, so that the management for the repayment prizes according to the prize-winning point numbers can be fixed and repayment points according to numbers of issued cards can be clearly managed.

Further, when the cards are encoded, the prize-winning points are magnetically recorded in the cards 1, and the cards are issued not according to the prize-winning point numbers but in a sequence according to random digits, that is, the cards are randomly issued, so that the cards 1 having prize-winning point numbers cannot be discriminated. This random issuance of cards can prevent a shop manager or clerk from optionally giving cards of higher prize-winning points to the customers, when the cards are supplied to the shop and given to the customers.

FIG. 4A is a view schematically describing several states of a card, which shows a process in which points are accumulated according to a customer's using of the card and the prize-winning is determined.

When the customer 10 visits the shop 20 and makes an initial purchase, an already-encoded card 1 is given to the customer 10 (step S31a). In this case, the shop 20 inputs information about the card 1, such as a membership code, shop code, an customer's name and telephone number, into the card 1 (step S32a), and prints a corresponding number of symbols such as an asterisk to a purchase point according to the initial purchase (step S33a), before issuing the card 1.

When the customer makes continuous purchases and gets a line of printed symbols, a prize-winning character such as a smile character is printed in a prize-winning blank (step S34a). Thereafter, when the symbols increase through continuous purchases, prize-winning characters such as shown characters in a sequence of a flower, bell, flower, and smile is randomly and continuously filled in prize-winning blank (step S35a). When the blank is completely filled with the prize-winning characters, points are given only for the smile character printed on the card 1. That is, in the card shown in FIG. 4A, since four smile characters are printed in the prize-winning blank, 300 points are given and 500 points are added as a blank-full bonus (step S36a).

In other words, the privilege corresponding to prize-winning points, which is described in the advice note, increases as the number of the prize-winning characters increases, so as to induce the customer's continuous purchases, and bonus points for congratulating on the blank-full are added when the card has been completely used, thereby giving more privilege to the customers.

FIG. 4B is a view schematically describing several states of a card, which shows another process in which points are accumulated according to a customer's using of the card and the prize-winning is determined.

When the customer 10 visits the shop 20 and makes an initial purchase, an already-encoded card 1 is given to the customer 10 (step S31b). In this case, the shop 20 inputs information about the card 1, such as a membership code, shop code, an customer's name and telephone number, into the card 1 (step S32b), and prints a corresponding number of symbols such as an asterisk to a purchase point according to the initial purchase (step S33b), before issuing the card 1.

When the customer makes continuous purchases and gets a line of printed symbols (asterisks), prize-winning characters such as a line of three flower characters are printed in a prize-winning blank (step S34b). Thereafter, when the symbols increase through continuous purchases, lines of prize-winning characters, such as lines of characters arranged in a sequence as shown, that is, including a sequence of a flower, flower, and bell, sequence of a bell, bell, bell, and a sequence of a flower, flower, and smile, are randomly and continuously filled in prize-winning blank (step S35b).

When the prize-winning blank is completely filled with the prize-winning characters (step S36b), points are given according to the characters printed on the card 1. That is, 500 points are given when a sequence of three bells have been printed, 1000 points are given when a sequence of three smiles have been printed, and 2000 points are given when a sequence of three flowers have been printed. Therefore, 2000 points, 500 points, and 100 points are given in steps S34b, S35b, and S36b, respectively, so that total 3500 points are given. Further, 500 points are added as the blank-full bonus, so that total 4000 points are given to the customer.

As described above, in the customer management method according to the present invention, utilizing a card 1 which can be printed and in which magnetic information can be recorded, symbols or characters are printed on the card corresponding to points set in advance products purchased by a customer, and repayment prize is given to the customer when the printed prize-winning characters correspond to a predetermined set of prize-winning characters.

The customer management method according to the present invention as described above can attract customer's interest through prize-winning whenever the customer makes a purchase, thereby increasing customer's anticipation and concern and securing regular customers.

Further, the customer management method according to the present invention enables customers to receive discriminated service and privilege through dividend of goods and enables shops to increase sales by securing more regular customers.

Moreover, in the customer management method according to the present invention, cards are issued after being previously encoded with prize-winning points according to total number of cards to be issued, so that the prize-winning points corresponding to the issued cards can be exactly managed, and prizes to be repaid to the customer for the prize-winning can be managed in advance according to a schedule.

In addition, in the customer management method according to the present invention, information and data about customers including sales record of shops can be accumulated and utilized in determining the prize-winning probabilities and points for cards to be issued in the future, thereby increasing the sales of the shops and the customers' satisfaction.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A customer management method comprising the steps of:
(1) issuing a card, in which an initial point number according to an initial purchase is initially encoded, and providing a customer with the card when the customer purchases a product;
(2) printing and accumulating a predetermined number of symbols corresponding to a point number according to purchase of products whenever the customer purchases products, together with at least one prize-winning character corresponding to the symbols; and
(3) providing the customer with a prize corresponding to a Prize-winning point set in advance, when the accumulated characters correspond to the prize-winning point.

2. A customer management method as claimed in claim 1, wherein a number of cards to be issued, the prize-winning point, and point numbers set for the products are determined based on data relating to customers and customers' purchase record stored and accumulated.

3. A customer management method as claimed in claim 1, wherein a prize-winning point total is differently distributed to and encoded in cards issued numbers of which are different according to the point numbers.

4. A customer management method as claimed in claim 3, wherein step 3 comprises the steps of:
inputting a total number of cards to be issued;
inputting a prize-winning point total of the cards;
inputting prize-winning point numbers according to kinds of the cards;
inputting a number of cards to be issued according to the prize-winning point numbers; and
issuing the cards according to the prize-winning point numbers.
